(19) United States
(12) Patent Application Publication
(10) Pub. No.: US 2016/0068679 A1
(43) Pub. Date: Mar. 10, 2016

(54) POLYMERIZABLE LACTAM COMPOSITION CONTAINING A SULFONATED POLYARYL SULFONE

(71) Applicant: BASF SE, Ludwigshafen (DE)

(72) Inventors: Philippe DESBOIS, Edingen-Neckarhausen (DE); Cecile SCHNEIDER, Frankenthal (DE)

(73) Assignee: BASF SE, Ludwigshafen (DE)

(21) Appl. No.: 14/781,386

(22) PCT Filed: Apr. 3, 2014
(86) PCT No.: PCT/EP2014/056663

§ 371 Date: Sep. 30, 2015

(30) Foreign Application Priority Data
Apr. 4, 2013 (EP) 13162347.2

(51) Int. Cl. C08L 81/06; C08L 77/02

(52) U.S. Cl. CPC C08L 81/06; C08L 77/02

(57) ABSTRACT

The present invention relates to a polymerizable lactam composition comprising at least one polymerizable lactam and at least one polaryl sulfone. The present invention further relates to a method of using the polymerizable lactam composition in the manufacture of polyamides and/or polyamide moldings.

The present invention relates to a polymerizable lactam composition comprising at least one polymerizable lactam and at least one polyaryl sulfone. The present invention further relates to a method of using the polymerizable lactam composition in the manufacture of polyamides and/or polyamide moldings.

Polyamides are currently in essence produced by condensation of dicarboxylic acids or derivatives thereof with diamines or by ring-opening polymerization of lactams. It is also known in principle to produce polyamides by activated anionic lactams polymerization. Lactams, for example caprolactam, lauryllactam, piperidone, pyrrolidone, etc., are for this ring-openingly polymerized in a base-catalyzed anionic polymerization reaction. This is generally accomplished by polymerizing a lactams melt comprising an alkaline catalyst and a so-called activator (or else co-catalyst or initiator) at elevated temperatures.

The activated anionic lactam polymerization process is described with reference to ε-caprolactam in Polyamides, Kunststoff Handbuch, Vol. 3/4, ISBN 3-446-16486-3, 1998, Carl Hanser Verlag, pages 49-52 and in Macromolecules, Vol. 32, No. 23 (1999), p. 7726.

DE-A-14 20 241 describes an anionic polymerization of lactams in the presence of an alkaline catalyst and with the use of 1,6-bis(N,N-dibutylureido)hexane as activator.

The unpublished EP 11176950.1 and EP 11172731.9 documents describe solid particles comprising a lactam monomer, a catalyst and an activator. This monomer composition is useful for producing polyamide by activated anionic polymerization. The particles in question are formed by spray drying, optionally followed by a grinding operation in the event of agglomerate formation.

Unpublished EP 12151670.9 describes solid particles which in addition to the lactam component, the catalyst and the activator may further also comprise non-functionalized and/or hydroxyl-terminated rubbers.

Molding materials comprising polyamides and polyaryl ether sulfones are known from the prior art. The polyaryl ether sulfones are used to modify the properties of the polyamides, such as heat resistance, dimensional stability or water imbibability. The limited degree of miscibility between polyaryl ether sulfones and polyamides greatly limits the success of molding compositions thus obtained.

WO 01/64792 describes molding compositions based on polyaryl ether sulfones and polyamides with an end group derived from a piperidine compound.

WO 01/83618 describes polyaryl ether sulfone/polyamide blends further comprising an epoxy resin, which have improved toughness and liquid flowability.

WO 2011/009789 describes nanocomposite blends comprising at least one thermoplastic polyamide, at least one polyaryl ether sulfone and at least one oxide and/or oxide hydrate of a metal or semimetal having a number-average diameter of 0.5 to 50 nm for the primary particles.

It is further known to modify polyaryl sulfones with sulfonic acid groups. Sulfonated polyaryl sulfones and their methods of making are described in US 2002/0091225 A1, US 2007/0163951 and WO 2010/146052.

However, none of the documents cited teaches providing a polymerizable lactam composition consisting of at least one lactam component and at least one sulfonated polyaryl ether sulfone for production of polyamides or polyamide moldings.

The problem addressed by the present invention was that of providing a polymerizable lactam composition leading to polyamide moldings having improved properties compared with the prior art. More particularly, the heat resistance of the polyamide shall be improved and/or its water imbibition reduced. The additive used for modifying the lactam composition shall be highly compatible with the lactam component. The polymerizable lactam composition shall further be obtainable in a simple manner.

It was found that, surprisingly, sulfonated polyaryl sulfones are the solution to this problem. Sulfonated polyaryl sulfones have good solubility in the molten lactam component and also good compatibility with the resulting polyamide even in the solid state. Corresponding homogeneous polymerizable compositions are obtainable faster than the prior art. It was further found that, surprisingly, the polyamide resulting from the lactam composition of the present invention has lower water imbibition than the prior art. When the lactam composition is used for a molding process and particularly for rotomolding, the lactam composition of the present invention makes it possible to charge the mold support with this lactam composition and not with an already polymerized polyamide and then to perform the polymerization in situ. This form of processing saves not just time but also energy, since the components needed to produce the molding generally only have to be heated once to a temperature above the melting point of the lactam component. It thus also becomes possible to formulate a polymerizable composition as a trade product to be shipped as a stable precursor to the final customer for conversion into moldings.

The invention first provides a polymerizable lactam composition comprising:
A) at least one polymerizable lactam, and
B) at least one sulfonated polyaryl sulfone where at least some of the aryl groups are substituted with at least one —SO₃X group, where X is hydrogen or one cation equivalent.

The invention further provides a process for producing a polyamide molding, which process comprises:
i) providing a polymerizable lactam composition as defined hereinabove and hereinbelow,
ii) subjecting the polymerizable composition provided in step i) to an anionic polymerization.

The invention further provides polyamide moldings obtainable by the process of the present invention.

The invention further provides a method of using the polymerizable lactam composition of the present invention in the manufacture of polyamides and polyamide moldings.

The polymerizable lactam composition of the present invention is preferably solid at room temperature under normal conditions (20° C., 1013 mbar). The polymerizable lactam composition of the present invention preferably also remains solid at higher temperatures. The polymerizable lactam composition of the present invention is preferably still solid at a temperature of at least 50° C., more preferably at a temperature of at least 60° C.

The term polyaryl sulfones in the context of the invention denotes polymers constructed of aryl repeat units linked via —SO₂— bridges. The aryl units may further also be linked in part via oxygen bridges. Polyaryl sulfones include, for example, polyether sulfones (PESU), polysulfones (PSU) and polyphenylene sulfones (PPSU). The naming of these plastics is in compliance with DIN EN ISO 1043-1:2011. The polyaryl sulfones of the present invention are sulfonated polyaryl sulfones, i.e., at least one of the aryl units is substituted with at least one —SO₃X group, where X is hydrogen or one cation equivalent. Sulfonated polyaryl sulfones include, for example, sulfonated polyether sulfones (sPESU), sulfonated polysulfones (sPSU) and sulfonated polyphenylene sulfones (sPPSU).

The viscosity number (Staudinger function, referred to as VN or J) is defined as VN=1/c×(η−ηₛ)/ηₛ. The viscosity number is directly related to the average molar mass of the polyamide and provides information about the processability of a polymer. The viscosity number is quantifiable according to EN ISO 307 by using a Ubbelohde viscometer.

The term “melt” in the context of the invention also denotes molten lactam and sulfonated polyaryl sulfone B) dissolved therein plus any further components dissolved therein, such as catalyst C) and/or activator D). In the context of the present invention, the term “melting” is not to be understood in its strict physicochemical sense, but as being interchangeable with conversion into a flowable liquid state.

By “degree of substitution of the sulfonated polyaryl sulfones with —SO₃X groups” (i.e., the degree of sulfonation) in the context of this invention is meant the number of —SO₃X substituents in mmol per 100 g of polyaryl sulfone.

By “one cation equivalent” in the context of the present invention is meant one cation of a single positive charge or one charge equivalent of a cation with two or more positive charges, for example Li, Na, K, Mg, Ca, NH₄, preferably Na, K.

The term “additives” in the context of the present invention comprehends filler and/or fibrous materials, added-substance materials and further polymers and monomers.

The polymerizable lactam composition of the present invention comprises with preference from 60 to 99.5 wt %, with particular preference from 75 to 98 wt %, of at least one lactam A) based on the combined weight of lactam A) and sulfonated polyaryl sulfone B).

The polymerizable lactam composition of the present invention comprises with preference from 0.5 wt % to 40 wt %, with particular preference from 2 wt % to 25 wt %, of at least one polyaryl sulfone B), based on the combined weight of lactam A) and sulfonated polyaryl sulfone B).

One preferred embodiment is a polymerizable lactam composition comprising
A) 60 wt % to 99.5 wt %, based on the combined weight of lactam component and sulfonated polyaryl sulfone, of at least one lactam, and
B) 0.5 wt % to 40 wt %, based on the combined weight of lactam component and polyaryl sulfone, of at least one polyaryl sulfone.

One particularly preferred embodiment is a polymerizable lactam composition comprising
A) 75 wt % to 98 wt %, based on the combined weight of lactam component and sulfonated polyaryl sulfone, of at least one lactam, and
B) 2 wt % to 25 wt %, based on the combined weight of lactam component and polyaryl sulfone, of at least one polyaryl sulfone.

The lactam composition of the present invention comprises at least one lactam A). Lactams A) are preferably selected from ε-caprolactam, 2-piperidone (δ-valerolactam), 2-pyrrolidone (γ-butyrolactam), capryllactam, enantholactam, lauryllactam and mixtures thereof. Caprolactam, lauryllactam or mixtures thereof are preferable. It is particularly preferable for the lactam used to be exclusively E-caprolactam or exclusively lauryllactam.

The lactam composition of the present invention comprises at least one sulfonated polyaryl sulfone B). Sulfonated polyaryl sulfones and their methods of making are known in principle to a person skilled in the art. DE 10149034, for example, discloses a method of preparing sulfonated polyarylene ether sulfones which utilizes amounts of a sulfonating agent which are stoichiometric in relation to the degree of substitution. Further methods of preparing sulfonated polyarylene ether sulfones are described in US 2002/0091225 A1 and US 2007/0163951 A1.

Preferably, the polyaryl sulfone B) is constructed of repeat units of general formula (I)

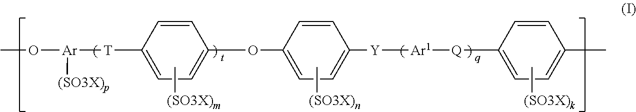

where
t and q are each independently 0, 1, 2 or 3,
Q, T and Y are each independently a chemical bond or selected from —O—, —S—, —SO₂—, —S(═O)—, —C(═O)—, —N═N—, —C(R^{a})═C(R^{b})— and —C(R^{c}R^{d})—,
   wherein R^{a} and R^{b} are each independently hydrogen or C₁-C₁₂ alkyl,
   R^{c} and R^{d} are each independently hydrogen, C₁-C₁₂ alkyl, C₁-C₁₂ alkoxy or C₆-C₁₈ aryl, wherein R^{c} and R^{d} C₁-C₁₂ alkyl, C₁-C₁₂ alkoxy or C₆-C₁₈ aryl is optionally substituted with fluorine and/or chlorine atoms,
   wherein R^{c} and R^{d} may also combine with the carbon atom to which they are attached to form a C₃-C₁₂ cycloalkyl group, wherein said C₃-C₁₂ cycloalkyl group is unsubstituted or substituted with one or more C₁-C₆ alkyl groups,
   wherein at least one of Q, T and Y is —SO₂—,
Ar and Ar¹ are each independently C₆-C₁₈ aryl, wherein said C₆-C₁₈ aryl is unsubstituted or substituted with at least one substituent selected from C₁-C₁₂ alkyl, C₁-C₁₂-alkoxy, C₆-C₁₈-aryl, halogen and —SO₃X,
p, m, n and k are each independently 0, 1, 2, 3 or 4, subject to the proviso that the sum total of p, m, n and k is not less than 1, and
X is hydrogen or one cation equivalent.

At least one of Q, T and Y being a chemical bond is to be understood as meaning that the chemical bond links the neighboring groups left and right together directly.

Preferably, the groups Q, T and Y in the compounds of formula (I) are each independently selected from —O— and —SO₂— subject to the proviso that at least one of Q, T and Y is —SO2—.

When at least one of the groups Q, T and Y is —C(R^{a})═C(R^{b})— or —C(R^{c}R^{d})—,
R^{a} and R^{b} are each independently hydrogen or C₁-C₁₂ alkyl,
R^{c} and R^{d} are each independently hydrogen, C₁-C₁₂ alkyl, C₁-C₁₂ alkoxy or C₆-C₁₈ aryl, wherein R^{c} and R^{d} C₁-C₁₂ alkyl, C₁-C₁₂ alkoxy or C₆-C₁₈ aryl is optionally substituted with fluorine and/or chlorine atoms,
wherein R^{c} and R^{d} may also combine with the carbon atom to which they are attached to form a C₃-C₁₂ cycloalkyl group, wherein said C₃-C₁₂ cycloalkyl group is unsubstituted or substituted with one or more C₁-C₆ alkyl groups,

Preferred C₁-C₁₂ alkyl groups include linear and branched, saturated alkyl groups of 1 to 12 carbon atoms. The following moieties are suitable in particular: C₁-C₆ alkyl, such as methyl, ethyl, n-propyl, i-propyl, n-butyl, sec-butyl, 2- or 3-methylpentyl or comparatively long-chain moieties such as unbranched heptyl, octyl, nonyl, cecyl, undecyl, lauryl, and the singly or multiply branched analogs thereof.

Alkyl moieties in the C₁-C₁₂ alkoxy groups used include the above-defined alkyl groups of 1 to 12 carbon atoms. Preferably used cycloalkyl moieties include in particular C₃-C₁₂ cycloalkyl moieties, e.g., cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, -cyclohexylmethyl, -dimethyl, -trimethyl.

Ar and Ar¹ are each independently C₆-C₁₈ aryl. Proceeding from the starting materials hereinbelow, Ar preferably derives from an electron-rich aromatic substance very susceptible to electrophilic attack, preferably selected from the group consisting of sulfonated or unsulfonated hydroquinone, resorcinol, dihydroxynaphthalene, in particular 2,7-dihydroxynaphthalene and 4,4′-bisphenol. Ar¹ is preferably an unsubstituted C₆ or C₁₂ arylene group.

Ar and Ar¹ in the preferred embodiment of formula (I) are each preferably selected independently from sulfonated or unsulfonated 1,4-phenylene, 1,3-phenylene, naphthylene, in particular 2,7-dihydroxynaphthalene and 4,4′-bisphenylene.

The polymerizable lactam composition of the present invention preferably utilizes polyarylene sulfones having the following structural units (Ia) to (Io):

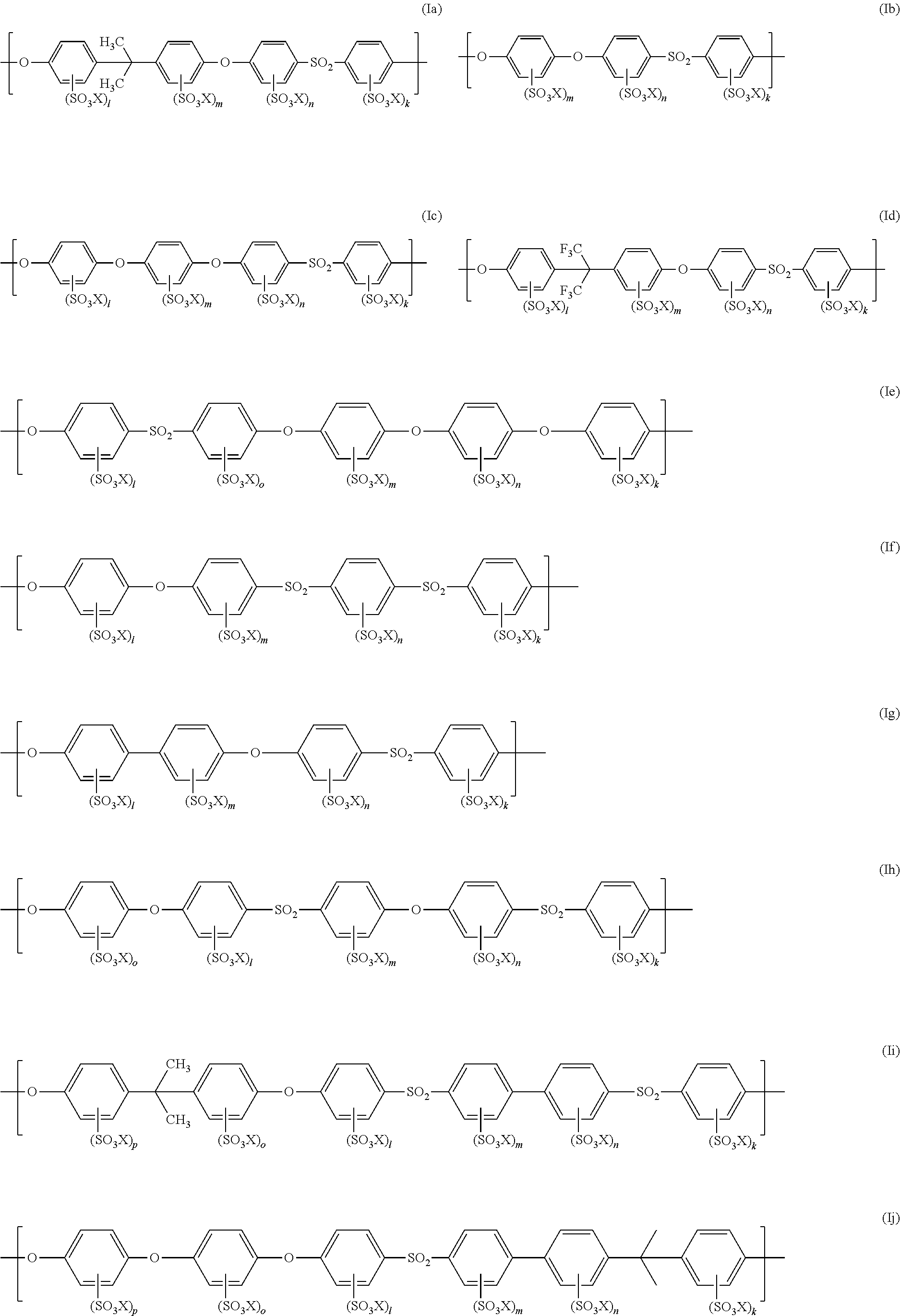

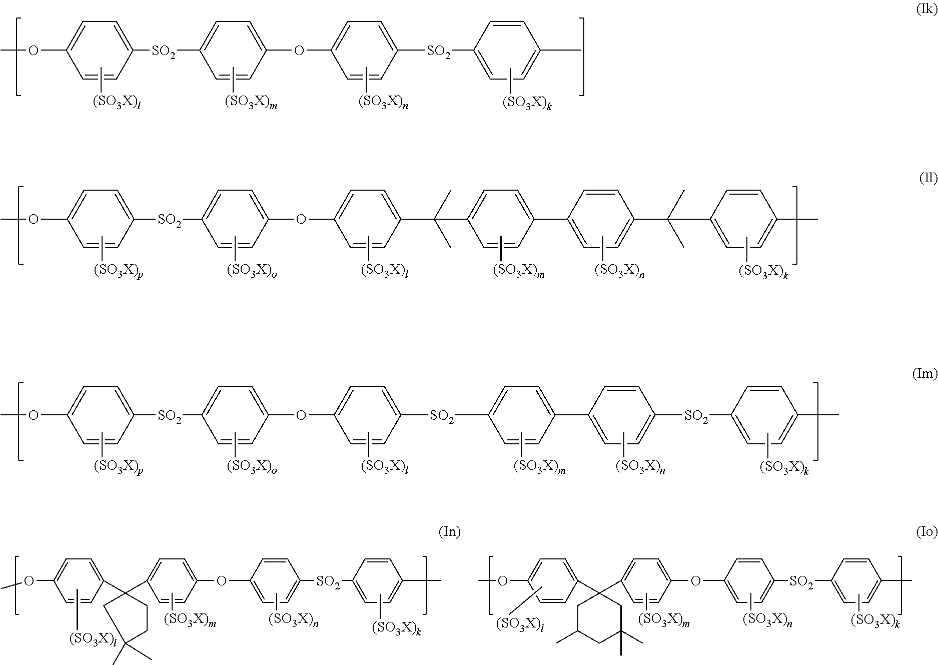

where
l, k, m, n, o, p are each independently 0, 1, 2, 3 or 4 subject to the proviso that the sum total of l, k, m, n, o and p is ≧1, and
X is hydrogen or one cation equivalent.

In addition to the preferred building blocks (Ia) to (Io), preference is also given to those structural units in which one or more sulfonated or unsulfonated 1,4-dihydroxyphenyl units are replaced by resorcinol or dihydroxynaphthalene.

Copolymers constructed of the various structural units in combination or of sulfonated and nonsulfonated structural units are also usable.

Structural units (Ia), (Ib), (Ig) and (Ik) or copolymers thereof are used with particular preference as repeat unit of general formula (I).

In one particularly preferred embodiment, Ar is 1,4-phenylene, t is 1, T is a chemical bond, Y is —SO2, q is 0, p is 0, m is 0, n is 1 and k is 1. Polyarylene ether sulfones constructed of this recited structural repeat unit are denoted sPPSU.

In a particularly preferred embodiment, Ar is 1,4-phenylene, t is 0, Y is —SO₂—, q is 0, n is 0 and k is 0. Polyarylene ether sulfones constructed of this recited structural repeat unit are denoted sulfonated polyether ether sulfones (sPEES).

In one advantageous embodiment, the sulfonated polyaryl sulfone B) comprises
a nonsulfonated repeat unit of formula (I)

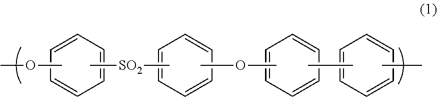

and a sulfonated repeat unit of formula (2)

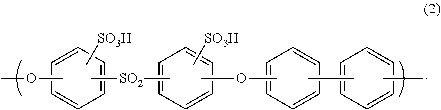

In particular, the sulfonated polyaryl sulfone B) consists exclusively of nonsulfonated repeat units of formula (I) and sulfonated repeat units of formula (2).

In a very advantageous embodiment, the sulfonated polyaryl sulfone B) comprises
a nonsulfonated repeat unit of formula (1a)

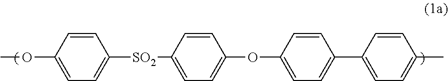

and a sulfonated repeat unit of formula (2a)

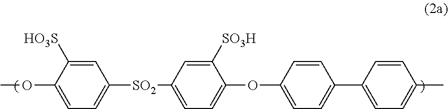

In particular, the sulfonated polyaryl sulfone B) consists exclusively of nonsulfonated repeat units of formula (1a) and sulfonated repeat units of formula (2a).

The polyaryl sulfones B) used according to the present invention preferably have a viscosity number of 20 ml/g to 80 ml/g, preferably of 20 ml/g to 60 ml/g. This viscosity number is quantified according to DIN EN ISO 1628-1 in a 1% solution of N-methyl-pyrrolidone (NMP) at 25° C.

The degree of substitution of the sulfonated polyaryl sulfones B) with —SO₃X groups is preferably in the range from 5 to 200 mmol/100 g of polyaryl sulfone, more preferably in the range from 10 to 150 mmol/100 g of polyaryl sulfone and especially in the range from 20 to 100 mmol/100 g of polyaryl sulfone.

According to the present invention, the polymerizable composition may comprise at least one catalyst C) and/or at least one activator D).

Suitable catalysts C) for employment in the process of the present invention are commonly used catalysts of the type customarily employed for anionic polymerization. They include specifically compounds that enable the formation of lactam anions. Lactam anions themselves may likewise act as a catalyst. Catalysts of this type are known for example from Polyamides, Kunststoff Handbuch, Vol. 3/4, 1998, Carl Hanser Verlag, p. 52.

Catalyst C) is preferably selected from sodium caprolactamate, potassium caprolactamate, bromide magnesium caprolactamate, chloride magnesium caprolactamate, magnesium biscaprolactamate, sodium hydride, sodium, sodium hydroxide, sodium methoxide, sodium ethoxide, sodium propoxide, sodium butoxide, potassium hydride, potassium, potassium hydroxide, potassium methoxide, potassium ethoxide, potassium propoxide, potassium butoxide and mixtures thereof.

It is particularly preferable to employ a catalyst C) selected from sodium hydride, sodium and sodium caprolactamate. Sodium caprolactamate in particular is employed as catalyst C). In one advantageous embodiment, a solution of sodium caprolactamate in caprolactam is employed. A mixture of this type is commercially available under the name Brüggolen® C10 from BrüggemannChemical, L. Brüggemann Kommanditgesellschaft, Germany and comprises 17 to 19 wt % of sodium caprolactamate in caprolactam. A likewise suitable catalyst C) is, in particular, bromide magnesium caprolactamate, e.g., Brüggolen® C1 from BrüggemannChemical, Germany.

The molar ratio of lactam A) to catalyst C) can be varied within wide limits, generally it is in the range from 1:1 to 10 000:1, preferably in the range from 5:1 to 1000:1 and more preferably in the range from 1:1 to 500:1.

The polymerizable lactam composition of the present invention preferably comprises at least one activator D)

Suitable activators D) for the anionic polymerization process are lactams N-substituted by electrophilic moieties, an example being an acyllactam.

Useful activators D) further include precursors to such activated N-substituted lactams, which combine with the lactam to form an activated lactam in situ. The number of growing chains depends on the activator quantity. Useful activators D) include in general isocyanates, acid anhydrides and acyl halides and/or reaction products thereof with the lactam monomer.

Useful activators D) include aliphatic, cycloaliphatic, araliphatic and aromatic diisocyanates. Useful aliphatic diisocyanates include, for example, tetramethylene diisocyanate, hexamethylene diisocyanate, octamethylene diisocyanate, decamethylene diisocyanate, undecamethylene diisocyanate and dodecamethylene diisocyanate. Useful aliphatic diisocyanates include, for example, 4,4′-methylenebis-(cyclohexyl)diisocyanate, isophorone diisocyanate and 1,4-diisocyanatocyclohexane. Useful aromatic diisocyanates include, for example, tolyl diisocyanate, 4,4′-diphenyl-methane diisocyanate, xylylene diisocyanate and tetramethylxylylene diisocyanate.

It is further possible to use polyisocyanates obtainable from the abovementioned diisocyanates, or mixtures thereof, by linking via urethane, allophanate, urea, biuret, uretdione, amide, isocyanurate, carbodiimide, uretoneimine, oxadiazinetrione or iminooxadiazinedione structures. These include, for example, the isocyanurate of hexamethylene diisocyanate. This is commercially available under the name Basonat HI 100 from BASF SE, Germany.

Useful activators D) further include aliphatic diacyl halides, such as butylenediacyl chloride, butylenediacyl bromide, hexamethylenediacyl chloride, hexamethylenediacyl bromide, octamethylenediacyl chloride, octamethylenediacyl bromide, decamethylenediacyl chloride, decamethylenediacyl bromide, dodecamethylenediacyl chloride, dodecamethylenediacyl bromide, 4,4′-methylenebis(cyclohexanecarbonyl chloride), 4,4′-methylenebis(cyclohexanecarbonyl bromide), isophoronediacyl chloride, isophoronediacyl bromide; and also aromatic diacyl halides, such as tolylmethylenediacyl chloride, tolylmethylenediacyl bromide, 4,4′-methylenebis(phenylcarbonyl chloride), 4,4′-methylenebis(phenylcarbonyl bromide). Mixtures of the recited compounds can also be employed as activators D).

Particular preference is given to a polymerizable lactam composition comprising an activator D) comprising at least one compound selected from the group consisting of aliphatic diisocyanates, aromatic diisocyanates, polyisocyanates, aliphatic diacyl halides and aromatic diacyl halides.

The activator D) employed in a preferred embodiment is at least one compound selected from hexamethylene diisocyanate, hexamethylene 1,6-dicarbamoyl-caprolactam (i.e., caprolactam-blocked 1,6-hexamethylene diisocyanate), isophorone diisocyanate, hexamethylenediacyl bromide, hexamethylenediacyl chloride and mixtures thereof. It is particularly preferable to employ hexamethylene 1,6-dicarbamoylcaprolactam as activator D). This is commercially available as Brüggolen® C20 from BrüggemannChemical, Germany.

The molar ratio of lactam A) to activator D) can be varied within wide limits and is generally in the range from 1:1 to 10 000:1, preferably in the range from 5:1 to 2000:1 and more preferably in the range from 20:1 to 1000:1.

The polymerizable lactam composition of the present invention may in addition to the aforementioned components A) and B) and also optionally C) and/or D) further comprise at least one further, different component.

In one advantageous embodiment, the polymerizable lactam composition of the present invention comprises at least one filler and/or fibrous material E). The term “filler and/or fibrous material” shall be construed broadly in the context of the present invention and comprehends particulate fillers, fibrous materials and any desired transitional forms. Particulate fillers may have a wide span of particle sizes, ranging from dusts to coarse-grain particles. Organic or inorganic filler and/or fibrous materials come into consideration as filling material. Usable examples include inorganic fillers, such as kaolin, chalk, wollastonite, talc, calcium carbonate, silicates, titanium dioxide, zinc oxide, graphite, glass particles, e.g., glass beads, nanoscale fillers, such as carbon nanotubes, carbon black, nanoscale sheet-silicates, nanoscale alumina (Al₂O₃), nanoscale titania (TiO₂), graphene, sheet-silicates and nanoscale silica (SiO₂).

It is further possible to use one or more fibrous materials. These are preferably selected from known inorganic reinforcing fibers, such as boron fibers, glass fibers, carbon fibers, silica fibers, ceramic fibers and basalt fibers; organic reinforcing fibers, such as aramid fibers, polyester fibers, nylon fibers, polyethylene fibers and natural fibers, such as wood fibers, flax fibers, hemp fibers and sisal fibers.

It is particularly preferable to use glass fibers, carbon fibers, aramid fibers, boron fibers, metal fibers or potassium titanate fibers. Chopped glass fibers are used specifically. The recited fibers are preferably used in the polymerizable composition in the form of short fibers. The average length of these short fibers is preferably in the range from 0.1 to 0.4 mm. It is also possible to use fibrous materials in the form of long fibers or as a blend of short and long fibers. In this case, however, it is advantageous to place them directly in the mold support, as described hereinbelow for laid fiber scrims or for fiber braids. Suitable fibers then also include fibers having an average fiber length in the range from 0.5 to 1 mm and long fibers whose average fiber length is preferably above 1 mm and more preferably in the range from 1 to 10 mm. For direct use in the mold support there is in principle no upper limit to the length of suitable fibers. For instance, fiber length in laid fiber scrims or in fiber braids is practically infinite.

In particular, it is also possible to use mixtures of the recited fillers and/or fibrous materials. It is particularly preferable to use glass fibers and/or glass particles, in particular glass beads, as filler and/or fibrous material E).

The polymerizable lactam composition of the present invention comprises with preference from 25 to 90 wt % and with particular preference from 30 to 80 wt % of at least one filler and/or fibrous material E), based on the overall weight of the polymerizable lactam composition.

In one advantageous embodiment, the polymerizable lactam composition of the present invention comprises from 30 to 50 wt % of at least one filler and/or fibrous material E), based on the overall weight of the polymerizable lactam composition. In a further advantageous embodiment, the polmerizable lactam composition of the present invention comprises from 51 to 90 wt % of at least one filler and/or fibrous material E), based on the overall weight of the polymerizable lactam composition.

In one advantageous embodiment, the polymerizable lactam composition of the present invention comprises at least one added-substance material F). The added-substance material F) is selected from polymers and further added-substance materials.

The polymerizable lactam composition may comprise one or more added polymers F). The polymer may in principle be selected from polymers as obtained in the polymerization of the lactam composition according to the present invention, polymers other than that and mixtures thereof.

The polymerizable lactam composition of the present invention preferably comprises at least one added polymer in an amount of 0 to 40 wt %, preferably in an amount of 0 to 20 wt %, more preferably in an amount of 0 to 10 wt %, based on the overall weight of the polymerizable lactam composition. When the polymerizable lactam composition comprises at least one added polymer, the amount thereof is preferably at least 0.1 wt % and more preferably at least 0.5 wt %, based on the overall weight of the polymerizable lactam composition.

Polymer F) is preferably selected from polystyrene, styrene copolymers, polyolefins, polyesters, polyethers, polymers of vinyl-containing monomers and mixtures thereof. In one preferred embodiment, the polymerizable lactam composition comprises at least one polymer selected from styrene-acrylonitrile copolymers (SAN), acrylonitrile-butadiene-styrene copolymers (ABS), styrene-butadiene copolymers (SB), high-temperature polyethylene (HTPE), low-temperature polyethylene (LTPE), polypropylene, polybutene-1, polytetrafluoroethylene, polyethylene terephthalate (PET), polyamides, polyethylene glycol (PEG), polypropylene glycol, polyphenylene oxide ethers, polyvinyl chloride, polyvinylidene chlorides, polystyrene, impact-modified polystyrene, polyvinylcarbazole, polyvinyl acetate, polyvinyl alcohol, polyisobutylene, polybutadiene and mixtures thereof.

Polymer F) is preferably further selected from polymers suitable for formation of block and/or graft copolymers with the polymer formed from the lactam monomer. Examples of such groups are epoxy, amine, carboxyl, anhydride, oxazoline, carbodiimide, urethane, isocyanate and lactam groups.

The added polymers F) serve for example to improve the product properties, to improve the compatibility of components, to modify the viscosity, etc.

In one advantageous embodiment, the polymerizable lactam composition does not contain any added polymer F).

In one advantageous embodiment, the polymerizable lactam composition may comprise at least one further added-substance material F).

The polymerizable lactam composition of the present invention preferably comprises at least one further added-substance material in an amount of 0 to 10 wt %, preferably in an amount of 0 to 5 wt %, more preferably in an amount of 0 to 4 wt %, based on the overall weight of the polymerizable lactam composition.

Further added-substance materials F) may include, for example, stabilizers, such as copper salts, dyes, antistats, release agents, antioxidants, light stabilizers, PVC stabilizers, lubricants, flame retardants, blowing agents, propellants, impact modifiers, nucleators and combinations thereof. When the polymerizable lactam composition comprises at least one further added-substance material F), the amount thereof is preferably at least 0.01 wt %, more preferably at least 0.1 wt %, based on the overall weight of the polymerizable lactam composition.

It is preferable for the polymerizable lactam composition used according to the present invention to comprise an impact modifier as added-substance material. When a polymeric compound is used as impact modifier, it is encountered with the abovementioned polymers. In particular, a polydiene polymer (e.g., polybutadiene, polyisoprene) is used as impact modifier. These preferably comprise anhydride and/or epoxy groups. The glass transition temperature of the polydiene polymer is particularly below 0° C., preferably below -10° C. and more preferably below -20° C. The polydiene polymer may be based on a polydiene copolymer with polyacrylates, polyethylene acrylates and/or polysiloxanes and obtained via the commonly used processes (e.g., emulsion polymerization, suspension polymerization, solution polymerization, gas phase polymerization).

The lactam in the polymerizable lactam composition of the present invention may be anionically polymerized by methods known to a person skilled in the art. This generally requires a catalyst and/or an activator. Yet further additives are frequently added, generally by incorporating them in the flowable liquid polymerizable lactam composition (lactam melt) before the polymerization.

It is also further possible for the polymerizable composition to contain not only at least one lactam but in addition at least one monomer (M) copolymerizable therewith. Suitable monomers (M) include lactones and crosslinking monomers. The monomer is preferably selected from lactones. Preferred lactones include for example caprolactone and/or butyrolactone. The amount of monomer (M) here should not exceed 40 wt %, based on the overall weight of the components used. The proportion of (M) is preferably in the range from 0 to 30 wt %, more preferably in the range from 0.1 to 20 wt %, based on the overall weight of the components used. The polymerizable composition used according to the present invention may comprise a crosslinking monomer. Suitable crosslinking monomers include compounds having more than one group capable of copolymerizing with lactam monomers. Examples of such groups are epoxy, amine, carboxyl, anhydride, oxazoline, carbodiimide, urethane, isocyanate and lactam groups. Useful crosslinking monomers include for example amino-substituted lactams such as aminocaprolactam, aminopiperidone, aminopyrrolidone, aminolauryllactam or mixtures thereof, preferably aminocaprolactam, aminopyrrolidone or mixtures thereof, more preferably aminocaprolactam.

In one preferred embodiment of the invention, the polymerizable lactam composition does not contain any additional monomers (M). Exclusively lactams are used as monomers in this embodiment.

In order to obtain a very homogeneous polymerizable lactam composition, intensive mixing of the components is advantageous.

The temperature is chosen so that the lactam component is a flowable liquid. The temperature is typically in the range from 50° C. to 400° C.

The invention further provides the process for producing a polyamide molding wherein a polymerizable lactam composition as defined above is provided and may be subjected to an anionic polymerization.

The polymerizable lactam composition of the present invention is converted into a flowable liquid state by heating to a temperature of preferably 50° C. to 160° C., more preferably of 50° C. to 140° C. and especially of 50° C. to 100° C. The flowable liquid polymerizable lactam composition is introduced into a mold cavity. It is also possible for the molten polymerizable lactam composition to be applied to a textile using impregnating equipment.

Preferably, the polymerization of the polymerizable lactam composition is effected by heating to a temperature of 120 to 250° C. using injection molding, pressing, rotomolding, plasma spraying, powder coating, fluidized bed coating or application to fibers or textiles and melting by infrared radiation or laser radiation.

Converting the room temperature solid polymerizable lactam composition into a flowable liquid state is preferably effected at a temperature not less than the melting temperature of the lactam monomer used. This temperature is preferably not more than 180° C., more preferably not more than 160° C., especially not more than 120° C. and specifically not more than 90° C. The choice of temperature range depends on the choice of lactam(s).

In one preferred embodiment, the polymerizable composition is in the form of particles.

The polymerizable composition is specifically in the form of particles which have essentially the same composition in that every particle comprises components A), C) and D). Essentially the same composition in the context of the invention is to be understood as meaning that the composition of the particles is the same except for deviations resulting from a production process, for example those that usually occur during the weighing or metering of the components forming the particles. Every individual particle thus comprises all of the components needed for the polymerization reaction. Particles which specifically do not have the same composition are those which comprise only exclusively one, or which comprise only exclusively two, of components A), C) and D). The polymerizable composition used in the form of particles for the purposes of the present invention thus differs fundamentally from known dry-formulated polymerizable compositions (known as dry blends) of the prior art.

The average diameter of the particles is generally from 1 to 2000 μm, preferably from 10 to 1000 μm, more preferably from 50 to 500 μm and most preferably from 100 to 200 μm. This average diameter is quantifiable by light scattering or via sieve fractions, and is the volume-average diameter.

A further embodiment of the invention comprises introducing the polymerizable lactam composition, as described above, into a mold support of a rotomolder with subsequent heating and distribution of the polymerizable lactam composition by biaxial rotation of the mold support. The polymerization of the polymerizable lactam composition takes place thereafter with simultaneous biaxial rotation of the mold support.

A further embodiment comprises producing fiber-reinforced composite materials. The polymerizable lactam composition of the present invention may then be cured in a rotomolder together with a textile structure. In addition, the polymerizable lactam composition of the present invention may be applied to the textile structure e.g. by impregnating, casting, spraying, etc.

The textile structures preferably comprise fibers composed of inorganic minerals such as carbon, for example as low-modulus carbon fibers or high-modulus carbon fibers, silicated and non-silicated glasses of various kinds, boron, silicon carbide, potassium titanate, metals, metal alloys, metal oxides, metal nitrides, metal carbides and silicates, and also organic materials such as natural or synthetic polymers, for example polyacrylonitriles, polyesters, ultrahigh drawn polyolefin fibers, polyamides, polyimides, aramids, liquid crystal polymers, polyphenylene sulfides, polyether ketones, polyether ether ketones, polyetherimides, cotton, cellulose and other natural fibers, for example flax, sisal, kenaf, hemp or abaca. Preference is given to high-melting materials, for example glasses, carbon, aramids, potassium titanate, liquid crystal polymers, polyphenylene sulfides, polyether ketones, polyether ether ketones and polyetherimides, particular preference being given to glass fibers, carbon fibers, aramid fibers, steel fibers, potassium titanate fibers, ceramic fibers and/or other sufficiently heat-resistant polymeric fibers or strands.

The polyamide moldings obtained according to the present invention by polymerization of the lactam composition of the present invention as described above are notable in particular for a low level of water imbibition. This in turn generally leads to higher stiffness in the moist state. The water imbibition of a polyamide molding from a polymerizable lactam composition of the present invention is generally not more than 10%, preferably not more than 9.5%, in particular not more than 8%.

The residual monomer content of a polyamide molding obtained by polymerization of the lactam composition according to the present invention is preferably in the range from 2 to 5 wt %, more preferably in the range from 1 to 2 wt %, based on the entire lactam composition.

The invention is more particularly elucidated by means of the figures described hereinbelow and the examples. These figures and examples must not be construed as limiting the present invention.

### FIGURE DESCRIPTION

FIG. 1: transmission electron micrograph of a nylon-6 (PA6) blend with polyarylene ether sulfones (resolution 1:20000), PA6/PESU blend (PESU unsulfonated) (=comparative polymer)

FIG. 2: transmission electron micrograph of a nylon-6 (PA6) blend with polyarylene ether sulfones (resolution 1:20000), PA6/sPESU blend (sPESU 20% sulfonated)

FIG. 3: transmission electron micrograph of a nylon-6 (PA6) blend with polyarylene ether sulfones (resolution 1:20000), PA6/sPESU blend (sPESU 15% sulfonated)

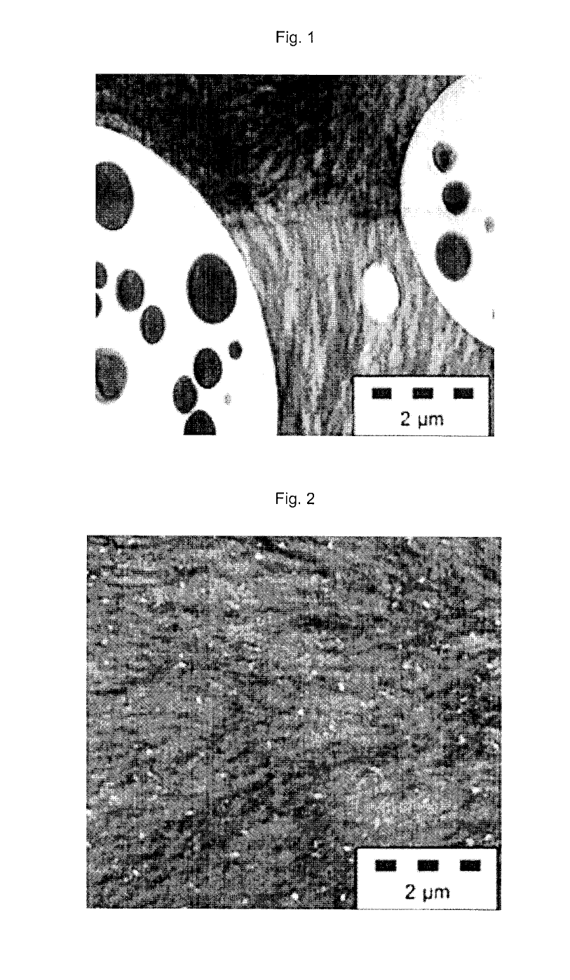

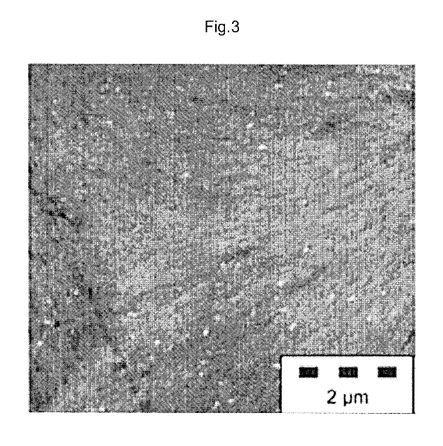

### EXAMPLES

Analytical Methods:

Viscosity number was determined for the polyarylene ether sulfones in accordance with DIN EN ISO 1628-1 in 1% solution of N-methylpyrrolidone (NMP) at 25° C.

The water imbibition of the polymerizable lactam composition was determined gravimetrically. A polymerized specimen (Ø=20 mm, height 4 mm) was stored in water at 80° C. for 24 h. After 24 h the water imbibition was determined gravimetrically.

The transmission electron micrographs were recorded with a Philips (FEI) CM120 TEM.

Dynamic scanning calorimetry (DSC) was carried out using a Maia DSC200F3 from Netzsch. Sample weight was about 10 mg, the heating and cooling rates were 20 K/min.

### I) Synthesis of Polyarylene Ether Sulfones

### Example 1

Sulfonated Polyarylene Ether Sulfone (P1) with 92.6 mmol SO₃H/100 g of Polymer

A polyarylene ether sulfone is obtained by nucleophilic aromatic polycondensation of 344.59 g of 4,4′-dichlorodiphenyl sulfone, 279.31 g of 4,4′-dihydroxybiphenyl and 147.38 g of disodium 3,3′-disulfonato-4,4′-dichlorodiphenyl sulfone by the action of 219.75 g of K₂O0₃ in 1575 mL of NMP. This mixture was maintained at 190° C. under nitrogen for 6 h. Thereafter, the batch was diluted by addition of 675 mL of NMP, the solid constituents were separated by filtration and the sulfonated polyarylene ether sulfone was isolated by precipitation in water. After careful washing with water, the product was dried at 150° C. under reduced pressure for 12 h.

Viscosity number: 35 mL/g.

### Example 2

Sulfonated Polyarylene Ether Sulfone (P2) with 70.75 mmol SO₃H/100 g of Polymer

A polyarylene ether sulfone is obtained by nucleophilic aromatic polycondensation of 366.13 g of 4,4′-dichlorodiphenyl sulfone, 279.31 g of 4,4′-dihydroxybiphenyl and 110.53 g of disodium 3,3′-disulfonato-4,4′-dichlorodiphenyl sulfone by the action of 219.75 g of K₂CO₃ in 1575 mL of NMP. This mixture was maintained at 190° C. under nitrogen for 6 h. Thereafter, the batch was diluted by addition of 675 mL of NMP, the solid constituents were separated by filtration and the sulfonated polyarylene ether sulfone was isolated by precipitation in water. After careful washing with water, the product was dried at 150° C. under reduced pressure for 12 h.

Viscosity number: 45 mL/g.

### Example 3

Synthesis of Polymerizable Lactam Composition (Reaction Mixture)

The anionic activated polymerization of ε-caprolactam is carried out in a conventional manner in the presence of a suitable ε-caprolactam soluble polymer. For this, the desired polyaryl sulfone (B) is initially dissolved at 160° C. in dry ε-caprolactam (A). Then, catalyst C) (ε-caprolactam and sodium caprolactamate, Brüggolen® C10)) is melted in the reaction mixture. The polymerization is started by adding activator D) (ε-caprolactam and N,N′-hexamethylenebis(carbamoyl-ε-caprolactam), Brüggolen® C20) at 160° C.

Table 1 shows the compositions of the reaction mixtures.

The reaction with unsulfonated polyarylene ether sulfone (PESU) (P0) was carried out for comparison in V3. PESU (P0) used had a viscosity number of 48 nl/g. The reaction was carried without polyarylene ether sulfone in comparative test V4.

TABLE 1
Composition of reaction mixtures

| | | | | | | | Polyarylsulfone B | |
|---|---|---|---|---|---|---|---|---|
| | ε-Caprolactam A | | Catalyst C | | Activator D | | | [% by |
| Test | [g] | [mmol] | [g] | [mmol] | [g] | [mmol] | [g] | mass] |
| 1 | 9.3 | 82.2 | 1.5 | 2.0 | 0.7 | 1.2 | 0.4 | 3 |
| (P1) | | | | | | | | |
| 1 | 9.3 | 82.2 | 1.5 | 2.0 | 0.7 | 1.2 | 0.6 | 5 |
| (P1) | | | | | | | | |
| 1 | 9.3 | 82.2 | 1.5 | 2.0 | 0.7 | 1.2 | 1.10 | 10 |
| (P1) | | | | | | | | |
| 2 | 9.3 | 82.2 | 1.5 | 2.0 | 0.7 | 1.2 | 0.4 | 3 |
| (P2) | | | | | | | | |
| 2 | 9.3 | 82.2 | 1.5 | 2.0 | 0.7 | 1.2 | 0.6 | 5 |
| (P2) | | | | | | | | |
| 2 | 9.3 | 82.2 | 1.5 | 2.0 | 0.7 | 1.2 | 1.10 | 10 |
| (P2) | | | | | | | | |
| V3 | 9.3 | 82.2 | 1.5 | 2.0 | 0.7 | 1.2 | 0.60 | 5 |
| (P0) | | | | | | | | |
| V4 | 9.3 | 82.2 | 1.5 | 2.0 | 0.7 | 1.2 | 0 | 0 |

Table 2 shows the solubility of the polyarylene ether sulfones. 5 wt % (based on the sum total of the components used) of polyarylene ether sulfone is dissolved in ε-caprolactam at 160° C. at a stirrer speed of 1000 rpm.

TABLE 2
Solubility of polyarylene ether sulfones in ε-caprolactam

| | | Complete | Residual |
|---|---|---|---|
| | Degree of sulfonation | dissolution | monomer |
| | [mmol of SO₃/100 g of | after t | content |
| | polyarylene ether sulfone] | [minutes] | [%] |
| P(1) | 92.6 | 425 | 1.9 |
| P(2) | 70.75 | 470 | 1.7 |
| P(0) | 0 | 1260 | 1.5 |
| V4 | 0 | 0 | 1.0 |

Table 3 shows the water imbibition of the polymerized lactam composition. The composition comprises 5 wt % (based on the sum total of the components used) of polyarylene ether sulfone. Water imbibition was determined gravimetrically as described above.

TABLE 3
Water imbibition

| | Degree of sulfonation | Water imbibition |
|---|---|---|
| | [mmol of SO₃/100 g of | in water |
| | polyarylene ether sulfone] | [%] |
| P(1) | 92.6 | 8.5 |
| P(2) | 70.75 | 8.9 |
| P(0) | 0 | 9.9 |

The sulfonation of the polyarylene ether sulfone enhances compatibility with nylon6 and leads to fine dispersal of the polyarylene sulfone in the PA6 matrix. FIG. 1 shows transmission electron micrographs of mixtures with 5 wt % of the polyarylene ether sulfone (P1 and P2) versus unsulfonated polyarylene ether sulfone (P0). The scale is 1:20 000.

Thermal properties of the lactam compositions obtained were investigated by dynamic scanning calorimetry (DSC) and are shown in table 4. The 1^{st} heating curve and the 1^{st} cooling curve were used for evaluation.

TABLE 4
Thermal properties
DSC (ΔHₘ⁰ = 190 J/g

| | T_{g} | Tₘ(peak) | ΔHₘ | T_{c}(peak) | ΔH_{c} |
|---|---|---|---|---|---|
| | [° C.] | [° C.] | [J/g] | [° C.] | [J/g]/[%] |
| 1 (P1) | 69.3 | 209.5 | 84.0 | 169.2 | 57.1 |
| 1 (P1) | 70.0 | 212.7 | 81.6 | 172.0 | 49.0 |
| 1 (P1) | 79.1 | 209.6 | 77.6 | 168.9 | 50.7 |
| 2 (P2) | 69.8 | 211.1 | 87.5 | 169.5 | 53.5 |
| 2 (P2) | 70.3 | 211.8 | 81.4 | 175.2 | 56.3 |
| 2 (P2) | 66.4 | 208.3 | 83.6 | 168.7 | 54.2 |
| V3 (P0) | 47.5 | 204.8 | 70.44 | 180.8 | 51.39 |
| V4 | 48.2 | 204.2 | 100.6 | 174.5 | 74.2 |

1. A polymerizable lactam composition comprising:
a polymerizable lactam, and
a sulfonated polyaryl sulfone, wherein at least one of the aryl groups is substituted with at least one —SO₃X group where X is a hydrogen or a cation equivalent thereof.

2. The polymerizable lactam composition according to claim 1, further comprising a catalyst.

3. The polymerizable lactam composition according to claim 1, further comprising an activator.

4. The polymerizable lactam composition according to claim 1 further comprising a filler and/or a fibrous material.

5. The polymerizable lactam composition according to claim 1, further comprising an added-substance material other than a filler and/or a fibrous material.

6. The polymerizable lactam composition according to claim 1, wherein the degree of substitution of the aryl groups of the sulfonated polyaryl sulfone with —SO₃X groups is 5-200 mmol/100 g of the sulfonated polyaryl sulfone.

7. The polymerizable lactam composition according to claim 1, wherein said polymerizable lactam is selected from the group consisting of ε-caprolactam, 2-piperidone, 2-pyrrolidone, capryllactam, enantholactam, lauryllactam and a mixture or mixtures thereof.

8. The polymerizable lactam composition according to claim 1, wherein said sulfonated polyaryl sulfone is constructed of repeat units of general formula (I): 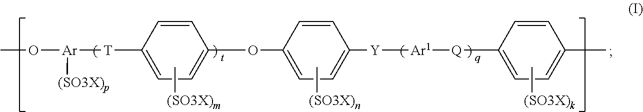
where:
t and q are each independently 0, 1, 2 or 3,
Q, T and Y are each independently a chemical bond or selected from the group consisting of —O—, —S—, —SO₂—, —S(═O)—, —C(═O)—, —N═N—, —C(R^{a})═C(R^{b})— and —C(R^{c}R^{d})—, where:
R^{a} and R^{b} are each independently a hydrogen or a C₁-C₁₂ alkyl,
R^{c} and R^{d} are each independently a hydrogen, a C₁-C₁₂ alkyl, a C₁-C₁₂ alkoxy or a C₆-C₁₈ aryl, wherein R^{c} and R^{d} the C₁-C₁₂ alkyl, the C₁-C₁₂ alkoxy and the C₆-C₁₈aryl are each optionally substituted with fluorine and/or chlorine atoms,
R^{c} and R^{d} may also optionally further combine with the carbon atom to which R^{c} and R^{d} are attached to form a C₃-C₁₂ cycloalkyl group, wherein said C₃-C₁₂ cycloalkyl group is unsubstituted or substituted with one or more C₁-C₆ alkyl groups,
Ar and Ar¹ are each independently a C₆-C₁₈ aryl, wherein said C₆-C₁₈ aryl is unsubstituted or substituted with at least one substituent selected from a C₁-C₁₂ alkyl, a C₁-C₁₂-alkoxy, a C₆-C₁₈-aryl, a halogen and —SO₃X,
p, m, n and k are each independently 0, 1, 2, 3 or 4, and are subject to the proviso that the sum total of p, m, n and k is not less than 1, and
X is a hydrogen or a cation equivalent thereof.

9. The polymerizable lactam composition according to claim 1, wherein said sulfonated polyaryl sulfone comprises:
a nonsulfonated repeat unit of formula (1) 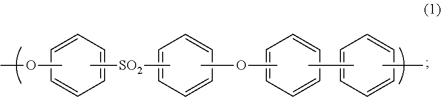
and
a sulfonated repeat unit of formula (2)

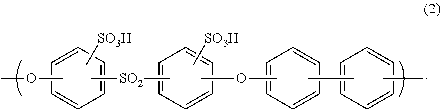

10. The polymerizable lactam composition according to claim 1, comprising:
60 wt % to 99.5 wt % of the polymerizable lactam, based on the combined weight of the polymerizable lactam and the sulfonated polyaryl sulfone; and
0.5 wt % to 40 wt % of the sulfonated polyaryl sulfone, based on the combined weight of the polymerizable lactam component and the sulfonated polyaryl sulfone.

11. A process for producing a polyamide molding, comprising:
subjecting the polymerizable lactam composition according to claim 1 to an anionic polymerization.

12. The process according to claim 11, wherein the polymerizable lactam composition is heated to a temperature of 1° C. to 20° C. above the melting point of the polymerizable lactam to produce and polymerize a flowable liquid composition.

13. The process according to claim 11, wherein the polyamide molding is produced in a rotomolder.

14. The process according to claim 11, wherein the polyamide molding is produced in an extruder.

15. The process according to claim 11, wherein:
the polymerizable lactam composition is in the form of particles having essentially the same composition; and
every particle comprises the polymerizable lactam, a catalyst and an activator.

16. A polyamide molding obtained by the process according to claim 11.

17. The polyamide molding according to claim 16, having a water imbibition of not more than 10%.

18. The polyamide molding according to claim 16, having a residual monomer content of 5 wt % to 2 wt %, based on the overall weight of the polymerizable lactam composition.
